(19) United States
(12) Patent Application Publication
(10) Pub. No.: US 2019/0188325 A1
(43) Pub. Date: Jun. 20, 2019

(54) DETERMINING CONNECTION SUGGESTIONS

(71) Applicant: Microsoft Technology Licensing, LLC, Redmond, WA (US)

(72) Inventors: Hongbo Zhao, San Jose, CA (US); Xia Song, Sunnyvale, CA (US); Yongqing Yuan, Mountain View, CA (US); Landi Yu, Fremont, CA (US)

(21) Appl. No.: 15/844,100

(22) Filed: Dec. 15, 2017

(51) Int. Cl. G06F 17/30

(52) U.S. Cl. CPC G06F 17/30867; G06F 17/30991

(57) ABSTRACT

In order to increase engagement of members with other members in the on-line social network system, a connection suggestions system is provided to help members effortlessly explore and connect with groups of people similar to them. In one embodiment, the connection suggestions system is configured to generate so-called cohorts of member profiles with respect to a subject member profile and include a visualization of the cohorts in a suggested network user interface (UI). The suggested network UI is generated to also include one or more visual controls actionable to permit the subject member to submit a connection request with respect to one or more of the member profiles included in the cohort.

### TECHNICAL FIELD

This application relates to the technical fields of software and/or hardware technology and, in one example embodiment, to system and method for generating an optimized visualization of a graph data structure stored in a database.

### BACKGROUND

An on-line social network may be viewed as a platform to connect people and share information in virtual space. An on-line social network may be a web-based platform, such as, e.g., a social networking web site, and may be accessed by a use via a web browser or via a mobile application provided on a mobile phone, a tablet, etc. An online social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system for determining connection suggestions in an on-line social network system may be implemented;

FIG. 2 is block diagram of a system for determining connection suggestions in an on-line social network system, in accordance with one example embodiment;

FIG. 3 is a flow chart of a method for determining connection suggestions in an on-line social network system, in accordance with an example embodiment:

FIG. 4 is an example user interface (UI) including a visualization of a cohort in the form of a graph; and

FIG. 5 is a diagrammatic representation of an example machine in the form of a computer system within which a set of instructions, for causing the machine to perform any one or more of the methodologies discussed herein, may be executed.

### DESCRIPTION

A method and system for determining connection suggestions in an on-line social network system in an on-line social network is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an online social networking application” may be referred to as and used interchangeably with the phrase “an online social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

An on-line social network may be viewed as a platform to connect people in virtual space, where registered members establish and document networks of people. Each registered member of an on-line social network may be represented by a member profile (also referred to as a profile of a member or simply a profile), which, in turn, may be represented by one or more web pages, a structured representation of the member's information in XML (Extensible Markup Language), JSON (JavaScript Object Notation) or similar format. A member's profile web page of a social networking web site may emphasize employment history and education of the associated member. A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, provide recommendations and endorsements for each other and otherwise be in touch via the social network. Connection distance between members represented by respective profiles in the on-line social network system may be expressed in degrees, where direct connections of a member (where social links indicating mutual connectedness are present in the member's profile and also in the profiles of her direct connections) are considered first degree connections, other members that are not directly connected to the member but connected to at least one of the member connections are considered second degree connections, still further members that are not directly connected to the members and are not connections of the member's connections but are connections of the second degree connections of the member are considered third degree connections, etc.

The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills, such as, e.g., “product management,” “patent prosecution,” “image processing,” etc.). The profile of a member may also include information about the member's current and past employment, such as company identifications, professional titles held by the associated member at the respective companies, as well as the member's dates of employment at those companies.

The on-line social network system is configured to enable members to interact and share information with other members. In order to increase engagement of members with other members in the on-line social network system, a connection suggestions system is provided to help members effortlessly explore and connect with groups of people similar to them. The connection suggestions system is also referred to as a Network You May Know system or merely NYMK. The data generation pipeline for NYMK is performed offline; different NYMK data is being generated periodically, e.g., per day. When a member requests their NYMK, they are presented with the pre-calculated data included in a NYMK user interface (LSI), also referred to as in a suggested network UI. The pre-calculated data included in a NYMK UI may change daily.

The technical problem of generating a user interface that presents a member with options for selecting new connections in the on-line social network system is addressed by configuring the connection suggestions system to automatically generate so-called cohorts of member profiles with respect to a subject member profile and to include a visualization of the cohorts in a suggested network UI. The suggested network UI is generated to also include one or more visual controls actionable to permit the subject member to submit a connection request with respect to one or more of the member profiles included in the cohort. A cohort is a set of member profiles, all of which include an indication of a particular value of a facet.. A facet can be understood as a category or a type of information that is included in an associated designated field in a member profile. For example, member profiles in the on-line social network system include a designated field for information about the current employment of the associated member—current employment field. A facet corresponding to that type of information may be a company facet. The value of the company facet for a subject member profile can be determined by examining the string entered by the subject member into the current employment field of the subject member profile. In addition to the company facet, other facets of a member profile include a school facet (providing information about one or more educational institutions attended by the member), title facet, geographic location facet, and industry facet. For the purpose of generating a cohort, a facet may be formed by a combination of facets. For example, a cohort for a subject profile may be selected with respect to a facet that combines the title and the geographic location into a title in a geographic location facet. Thus, for a subject member profile indicating the title facet value being “engineer” and geographic location being “San Francisco,” a cohort may be produced having member profiles representing other members who are engineers in San Francisco.

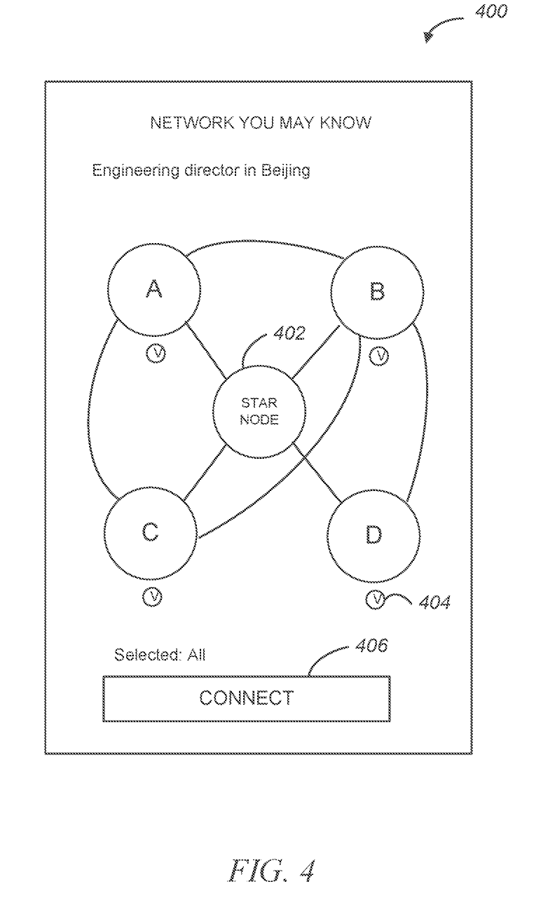

The visualization of a cohort may be in the form of a graph, which is referred to as a suggested network graph, for the purposes of this description. An example UI that includes visualization of a cohort in the form of a graph (the suggested network 400, which is also referred to as NYMK UI) is shown in FIG. 4. The UI 400 is constructed for and presented to a subject member represented by a subject member profile, with respect to the value of a facet indicated in the subject profile. As mentioned above, a facet used to select member profiles to be included in a cohort may be a company facet, a school facet, a title facet, a geographic location facet, an industry facet, or a facet that combines two or more facets, such as, e.g., a title in a geographic location facet. The construction of a cohort with respect to a given facet starts with identifying a connected profile—a member profile that is a first degree connection with respect to the subject profile and that has the same value of the given facet as the subject member profile. For example, the construction of a cohort with respect to a title in geographic location facet for a subject profile that indicates that the associated member is an engineering director in Beijing, starts with identifying a first degree connection of the member whose profile indicates that the connected member is also an engineering director in Beijing. In the suggested network graph included in the UT 400, the connected profile is represented by node 402, which is referred to as a super node for the purposes of this description. The super node in a suggested network graph represents a connected member profile that is the first degree connection with respect to the subject member profile and also the first degree connection with respect to each of the other profiles included in the associated cohort. The other profiles included in the associated cohort are selected based on criteria that includes the following: a profile is a first degree connection of the connected profile and a second degree connection of the subject profile and it indicates the same value of a given facet as the value of that facet indicated in the subject profile. In the example shown in FIG. 4, the given facet is a title in geographic location facet and the value of that facet is an engineering director in Beijing.

In some embodiments, the number of other profiles in the cohort that represent second degree connections of the subject profile are limited to a certain number (e.g., four) and each of the other profiles must be a first degree connection with at least one other profile in the cohort in addition to being the first degree connection with the connected profile represented by the super node in the suggested network graph. In the suggested network graph included in the UI 400, the other profiles included in the associated cohort are represented by nodes A, B, C, and D. The edges the suggested network graph represent first degree conn.ections between the associated member profiles. The profiles represented by the nodes A, C, and D are first degree connections with respect to the connected profile represented by the super node and second degree connections with respect to the subject profile. As shown in the suggested network graph included in the UI 400, nodes A and B, A and C, B and D, and C and B have respective edges that indicates the first degree connection between the associated profiles. The UI 400 also includes visual controls 404 that are actionable to select the associated node and a connect visual control 405 actionable to initiate a connection request to each member profile represented by the selected associated node.

The cohorts for a subject profile with respect to a facet are generated off lime. The connection suggestions system calculates the suggested network graphs with respect to a subject profile as follows. It first identifies first degree connections data for the subject profile using, e.g., social links stored in the subject profile indicating bilateral connectedness with other member profiles. The profiles in the first degree connections data are referred to as connected profiles with respect to the subject profile. The system then identifies for each facet, respective sets of connected profiles having the same facet value as the subject profile.

For a given connected profile having the same facet value as the subject profile, the system generates so-called suggested network triangle data. Each suggested network graph is broken into multiple triangles. In other words, a suggested network graph is assembled by combining multiple suggested network triangles that have the same super node—the node representing the connected profile. In one embodiment, the system generates, with respect to subject profile, second degree connection data with respect to each facet. As mentioned above, only those member profiles are being considered that have the same facet value as the subject profile. Thus, for each facet, in order to be included in a triangle, the second degree connection profile must have at least two first degree connections and must not be already directly connected to the subject profile.

After the suggested network graph triangles are generated, the system combines them into suggested network graphs. The resulting suggested network graphs do not have any isolated surrounding nodes with no connections to any other surrounding nodes. Surrounding nodes in a suggested connections graph are those nodes that are not the super node; they represent second degree connections of the subject profile, they are first degree connections with respect to the connected profile represented by the super node, and they have the same facet value as the subject profile and the connected profile. Different suggested network graphs are generated every day for with some other predetermined interval), such that members may see different graphs per day. An example algorithm of generating suggested network graphs for a subject member profile comprises collecting all triangles for a connected profile and each facet and, while scanning the triangles, generating and storing the resulting suggested network graph if there are enough triangles to form a suggested network graph. After generating each suggested network graph, using the next triangle as the initial triangle to see if it can still form a graph or not. These operations are repeated until no triangles remain for each connected profile and each facet.

The generated suggested network graphs are ranked using predetermined criteria, and the top number the highest-ranker 100 suggested network graphs) are stored for a given subject profile. The ranking criteria may include an average member-to-member acceptance rate for member profiles represented by the surrounding nodes. Different ranking weight may be attributed to different facets. For example, the suggested network graphs generated with respect to the company facet may be weighted by a greater coefficient than the suggested network graphs generated with respect to the industry facet. Also, if surrounding nodes in a graph already exist in previously examined suggested network graphs, the rank of that graph may be ranked down. The ranking down based on determining that one or more surrounding nodes in a graph already exist in previously examined suggested network graphs may be performed using a decay factor. In some embodiments, the rank of a suggested network graph may be calculated as the total of member-to-member accepted connection requests divided by the sum of the total of member-to-member accepted, pending and rejected connection requests. This can be expressed using Equation 1 shown below.

graph score=Sum(total M2M accept)/Sum(total M2M accept+pending+reject) Equation 1

For ranking down duplicate surrounding nodes, a decay factor can be used as expressed using Equation 2 below.

graph score=graph score*pow(DECAY_FACTOR, n) Equation 2

where pow(x,y) is a function that returns x raised to the power of y, and where n represents the total surrounding nodes that already appear n times in the previously examined graphs.

In some embodiments, the connection suggestions system is configured to monitor user interaction with NYMK data prevented vis the NYMK UI. If a member chooses to dismiss a particular suggested connections graph, he system sets the score for that graph to a negative value, so that that particular suggested connections graph is not presented again to that member (although it can still be presented to another member). If the connection suggestions system detects that a member viewed the graph but didn't send out any invitations, the system applies a so-called FACET_WEIGHT_FACTOR to rank down this graph by as expressed using Equation 3below.

graph score=graph score*FACET_WEIGHT_FACTOR

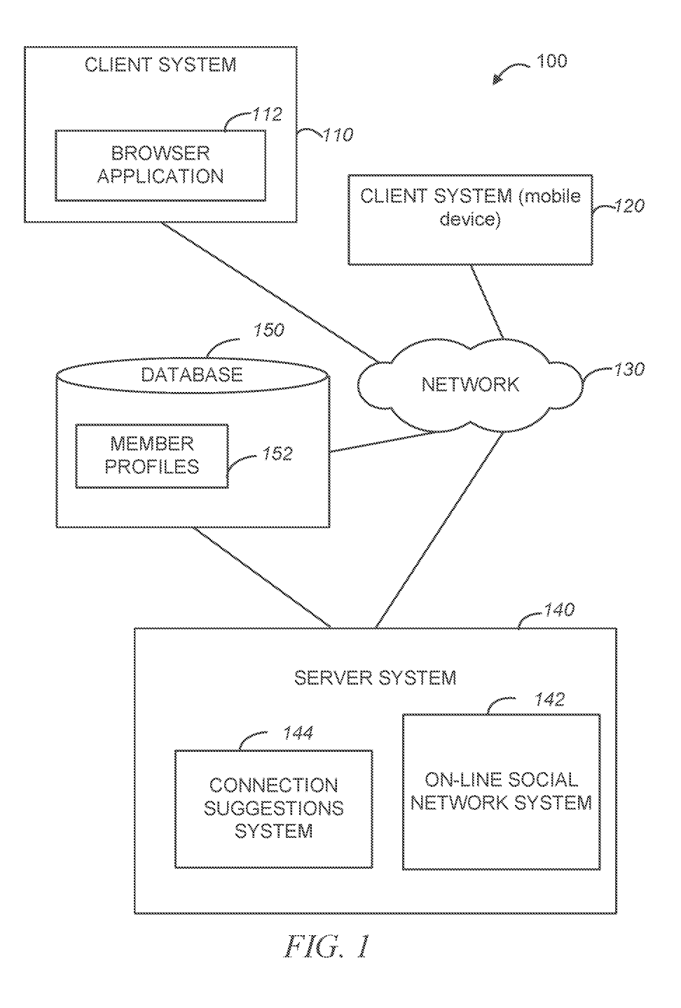

Each time after generating suggested network graphs, the graphs are validated before the system pushes that data to the database, from which that data is retrieved when a suggested network UI is generated. An example validation script is executed to verify data so as to ensure, for each suggested connections graph, that the super node has connections with all surrounding nodes, that there are no isolated surrounding nodes that have no connection with any other surrounding nodes, that there are no connections between the subject profile and profiles represented by surrounding nodes, and that the subject profile is connected to the profile represented by the super node. Example system for determining connection suggestions in an on-line social network system in an on-line social network system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

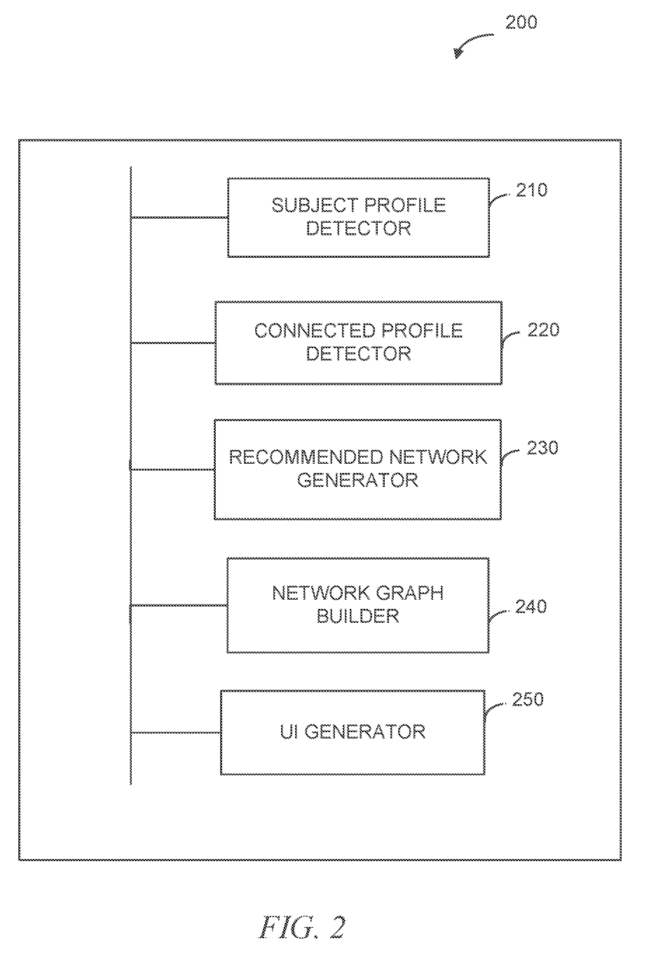

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a connection suggestions system 144 for determining suggested networks for member profiles, using the methodologies described herein. The connection suggestions system 144 may be part of or in communication with the on-line social network system 142. An example connection suggestions system 144 is illustrated in FIG. 2.

FIG. 2 is a block diagram of a system 200 for determining connection suggestions in an on-line social network system, in accordance with one example embodiment. The system 200, in some embodiments, corresponds to the connection suggestions system 1144. As shown in FIG. 2, the system 200 includes a subject profile detector 210, a connected profile detector 220, a recommended network generator 230, a network graph builder 240, and a generator 250.

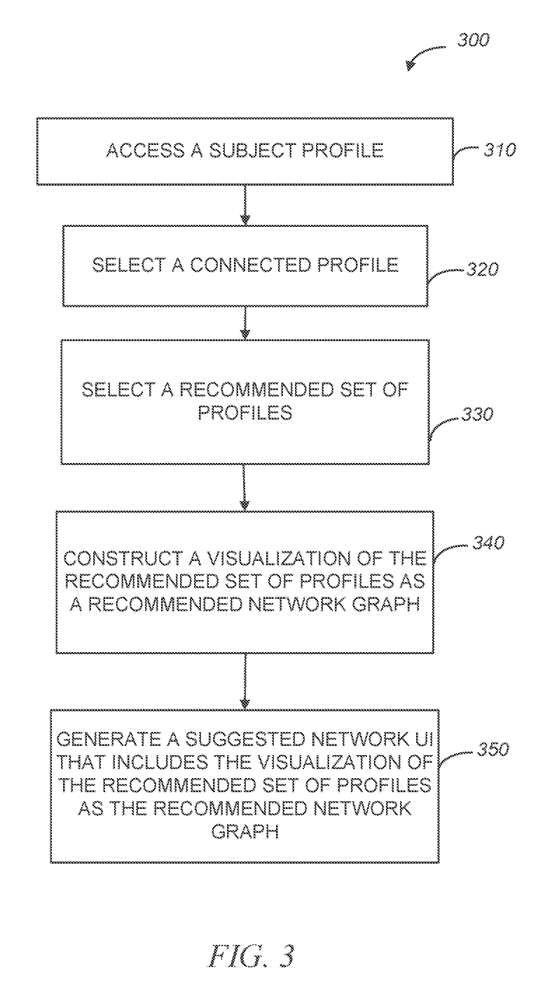

The subject profile detector 210 is configured to access a subject profile representing a member in an on-line social network system. The subject profile indicates a subject value of a facet. The connected profile detector 220 is configured to select a connected profile that includes a link indicating a first degree connection with the subject profile and also indicates the subject value of the facet. The recommended network generator 230 is configured to select a recommended set of profiles from member profiles that include respective links indicating a first degree connection with the connected profile. The network graph builder 240 is configured to construct a visualization of the recommended set of profiles as a recommended network graph, a first node in the recommended network graph representing the connected profile and additional nodes in the recommended network graph representing respective member profiles from the recommended set of profiles. An example of such visualization included in a suggested network UI is shown in FIG. 4 and described above. The UI generator 250 is configured to generate a suggested network UI that includes the visualization of the recommended set of profiles as the recommended network graph for presentation to the member. Some operations performed by the system 200 may be described with reference to FIG. 3.

FIG. 3 is a flow chart of a method 300 for determining connection suggestions in an on-line social network system, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the subject profile detector 210 of FIG. 2 accesses a subject profile representing a member in an on-line social network system. The subject profile indicates a subject value of a facet. The connected profile detector 220 of FIG. 2 selects, at operation 320, a connected profile that includes a link indicating a first degree connection with the subject profile and also indicates the subject value of the facet. At operation 330, the recommended network generator 230 of FIG. 2 selects a recommended set of profiles from member profiles that include respective links indicating a first degree connection with the connected profile. The network graph builder 240 of FIG. 2 constructs, at operation 340, a visualization of the recommended set of profiles as a recommended network graph. A first node in the recommended network graph represents the connected profile and additional nodes in the recommended network graph represent respective member profiles from the recommended set of profiles. At operation 350, he UI generator 250 of FIG. 2 generates a suggested network UI that includes the visualization of the recommended set of profiles as the recommended network graph for presentation to the member.

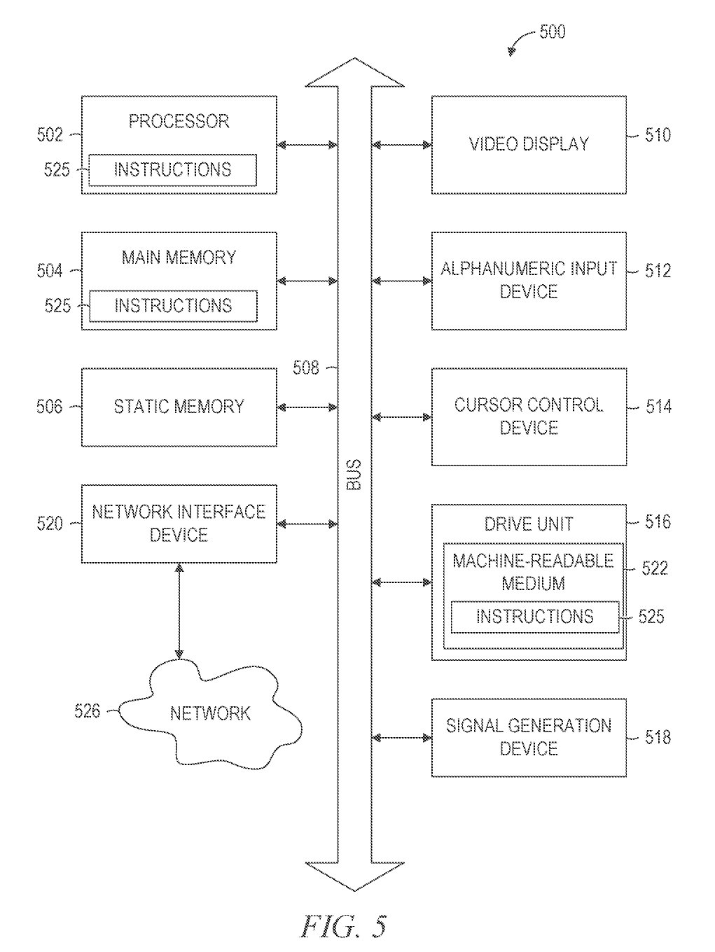

FIG. 5 is a diagrammatic representation of a machine in the example form of a computer system 500 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor 502 (e.g., a central processing unit (CPU), a graphics processing unit (CPU) or both), a main memory 504 and a static memory 506, which communicate with each other via a bus 504. The computer system 500 may further include a video display unit 510 (e.g., a liquid crystal display (LCD) or a cathode ray tube (CRT)). The computer system 500 also includes an alpha-numeric input device 512 (e.g., a keyboard), a, user interface (UI) navigation device 514 (e.g., a cursor control device), a disk drive unit 51.6, a signal generation device 518 (e.g., a speaker) and a network interface device 520.

The disk drive unit 516 includes a machine-readable medium 522 on which is stored one or more sets of instructions and data structures (e.g., software 524) embodying or utilized by any one or more of the methodologies or functions described herein. The software 524 may also reside, completely or at least partially, within the main memory 504 and/or within the processor 502 during execution thereof by the computer system 500, with the main memory 504 and the processor 502 also constituting machine-readable media.

The software 524 may further be transmitted or received over a network 526 via the network interface device 520 utilizing any one of a number of well-known transfer protocols (e.g., Hyper Text Transfer Protocol (HTTP)).

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (R)Ms), and the like

The embodiments described herein ma be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may he implemented mechanically or electronically. For example, a hardware-implemented module may comprise dedicated circuitry or logic that is permanently configured (e.g., as a special-purpose processor, such as a field programmable gate army (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may he distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may he performed by a group of computers (as examples of machines including processors), these operations being accessible via a network (e.g., the Internet) and via one or more appropriate interfaces (e.g., Application Program Interfaces (APIs).)

Thus, method and system for determining connection suggestions in an on-line social network system have been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
accessing a subject profile representing a member in an on-line social network system, the subject profile indicating a subject value of a facet;
selecting a connected profile that includes a link indicating a first degree connection with the subject profile and also indicates the subject value of the facet;
from member profiles that include respective links indicating a first degree connection with the connected profile, select a recommended set of profiles;
using at least one processor couples to a memory, constructing a visualization of the recommended set of profiles as a recommended network graph, a first node in the recommended network graph representing the connected profile and additional nodes in the recommended network graph representing respective member profiles from the recommended set of profiles; and
generating a suggested network user interface (UI) that includes the visualization of the recommended set of profiles as the recommended network graph for presentation to the member.

2. The method of claim 1, comprising causing presentation, on a display device, the suggested network user

3. The method of claim 1, wherein the generating of the suggested network UI comprises including, in the suggested network UI, a plurality of selection controls actionable to indicate selection of a member profile represented by a node in the recommended network graph and a connect control actionable to initiate a connection request to one or more selected members profile represented by respective selected nodes.

4. The method of claim 1, wherein the facet is a type of information that is included in an associated designated field in profiles maintained in the on-line social network system.

5. The method of claim 1, wherein the selecting of the recommended set of profiles comprises determining that each profile from the recommended set of profiles includes a social link indicating the first degree connection with the connected profile and does not include a social link indicating the first degree connection with the subject profile.

6. The method of claim 1, wherein the selecting of the recommended set of profiles comprises determining that each profile from the recommended set of profiles includes a social link indicating the first degree connection with at least one other profile from the recommended set of profiles.

7. The method of claim 1, comprising generating a rank for the recommended network graph and selecting the recommended network graph for including it into the suggested network user UI based on the rank.

8. The method of claim 7, wherein the generating of the rank is based on an average member-to-member acceptance rate for member profiles from the recommended set of profiles and/or based on a determination that a node in the recommended network graph is also included in another recommended network graph generated with respect to the subject profile.

9. The method of claim 7, wherein the generating of the rank is based on a weight assigned to the facet.

10. The method of claim 1, wherein the facet is from a plurality of facets and the method includes selecting a further recommended set of profiles for the subject member profile with respect to a further facet from the plurality of facets.

11. A system comprising:
one or more processors; and
a non-transitory computer readable storage medium comprising instructions that when executed by the one or processors cause the one or more processors to perform operations comprising:
accessing a subject profile representing a member in an on-line social network system, the subject profile indicating a subject value of a facet;
selecting a connected profile that includes a link indicating a first degree connection with the subject profile and also indicates the subject value of the facet;
from member profiles that include respective links indicating a first degree connection with the connected profile, select a recommended set of profiles;
constructing a visualization of the recommended set of profiles as a recommended network graph, a first node in the recommended network graph representing the connected profile and additional nodes in the recommended network graph representing respective member profiles from the recommended set of profiles; and
generating a suggested network user interface (UI) that includes the visualization of the recommended set of profiles as the recommended network graph for presentation to the member.

12. The system of claim 11, comprising causing presentation, on a display device, the suggested network user UI.

13. The system of claim 11, wherein the generating of the suggested network comprises including, in the suggested network UI, a plurality of selection controls actionable to indicate selection of a member profile represented by a node in the recommended network graph and a connect control actionable to initiate a connection request to one or more selected members profile represented by respective selected nodes.

14. The system of claim 11, wherein the facet is a type of information that is included in an associated designated field in profiles maintained in the on-line social network system.

15. The system of claim 11, wherein the selecting of the recommended set of profiles comprises determining that each profile from the recommended set of profiles includes a social link indicating the first degree connection with the connected profile and does not include a social link indicating the first degree connection with the subject profile.

16. The system of claim 11, wherein the selecting of the recommended set of profiles comprises determining that each profile from the recommended set of profiles includes a social link indicating the first degree connection with at least one other profile from the recommended set of profiles.

17. The system of claim 11, comprising generating a rank for the recommended network graph and selecting the recommended network graph for including it into the suggested network user UI based on the rank.

18. The system of claim 17, wherein the generating of the rank is based on an average member-to-member acceptance rate for member profiles from the recommended set of profiles and/or based on a determination that a node in the recommended network graph is also included in another recommended network graph generated with respect to the subject profile.

19. The system of claim 17, wherein the generating of the rank is based on a weight assigned to the facet.

20. A machine-readable non-transitory storage medium having instruction data executable by a machine to cause the machine to perform operations comprising:
accessing a subject profile representing a member in an on-line social network system, the subject profile indicating a subject value of a facet;
selecting a connected profile that includes a link indicating a first degree connection with the subject profile and also indicates the subject value of the facet;
from member profiles that include respective links indicating a first degree connection with the connected profile, select a recommended set of profiles;
constructing a visualization of the recommended set of profiles as a recommended network graph, a first node in the recommended network graph representing the connected profile and additional nodes in the recommended network graph representing respective member profiles from the recommended set of profiles; and
generating a suggested network user interface (UI) that includes the visualization of the recommended set of profiles as the recommended network graph for presentation to the member.
